(19) United States
(12) Patent Application Publication
(10) Pub. No.: US 2017/0014940 A1
(43) Pub. Date: Jan. 19, 2017

(54) Methods of Fabricating a Track Shoe Using Friction Welding and Resultant Track Shoes

(71) Applicant: Caterpillar Inc., Peoria, IL (US)

(72) Inventors: Timothy Thorson, Morton, IL (US); David P. Fitzgibbons, Metamora, IL (US); Michael D. Hasselbusch, Metamora, IL (US); Mark S. Diekevers, Germantown Hills, IL (US); Tao Lin, Mettawa, IL (US); Cedric Tabone, Dunlap, IL (US)

(73) Assignee: CATERPILLAR INC., Peoria, IL (US)

(21) Appl. No.: 14/799,125

(22) Filed: Jul. 14, 2015

(51) Int. Cl. B23K 20/12; B62D 55/24

(52) U.S. Cl. CPC B23K 20/129; B23K 20/122; B62D 55/24

(57) ABSTRACT

Methods of fabricating track shoes for an endless track using friction welding are provided. One method includes fabricating a track shoe by friction welding a grouser to a track shoe blank. Another method includes fabricating a track shoe by friction welding a first track shoe portion that includes a grouser to a second track shoe portion.

### TECHNICAL FIELD

The present disclosure relates generally to track shoes for an endless track of a tracked undercarriage and, more particularly, to methods of fabricating a track shoe using friction welding.

### Background

Many track-type machines have tracked undercarriages that move along the ground as the machine travels. Examples of track-type machines with tracked undercarriages may include, but are not limited to, excavators, tractors, dozers, and the like. Generally, tracked undercarriages include an endless or continuous track driven around two or more wheels. An endless track can better distribute the force the track-type machine applies to the ground as a result of the large surface area of the track as compared to the wheels alone. This may allow a track-type machine with an endless track to traverse soft ground with lower likelihood of becoming stuck, for example, due to sinking In addition to distributing the force the track-type machine applies to the ground over a wider area, endless tracks may also increase traction and durability of the machine.

The endless track of a tracked undercarriage is often made of modular plates called track shoes. Track shoes are typically made from special rolled sections of steel that require expensive tooling to manufacture. A track shoe may include a grouser, which is a component that protrudes from a surface of the track shoe that increases the traction of the endless track. It is particularly challenging to manufacture a track shoe with a grouser, especially for larger track-type machines.

A method of replacing a wear bar on a crawler using friction welding is disclosed in U.S. Patent Application Publication No. 2008/0309157. However, the method does not alleviate the problem of fabricating a fully formed track shoe with a grouser using friction welding.

### SUMMARY

In one aspect, the present disclosure describes a method of fabricating a track shoe that comprises friction welding a grouser to a track shoe blank. In another aspect, the present disclosure describes a method of fabricating a track shoe that comprises friction welding a first track shoe portion that includes a grouser to a second track shoe portion. In yet another aspect, the present disclosure describes a track shoe that comprises a track shoe blank and a grouser that protrudes from a flat portion of the track shoe blank and that is fused to the track shoe blank by friction welding. In still another aspect, the present disclosure describes a track shoe that comprises a first track shoe portion that includes a grouser and a second track shoe portion fused to the first track shoe portion by friction welding.

### BRIEF DESCRIPTION OF THE DRAWINGS

FIG. 1 is a side view of an exemplary machine including a track assembly with an endless track comprised of track shoes in accordance with the present disclosure.

FIG. 2 is a side view of the track assembly of the machine of FIG. 1.

FIG. 3 is a perspective view of an exemplary track shoe of the track assembly of FIG. 2.

FIG. 4 is a side view of a track shoe blank in accordance with the present disclosure.

FIG. 5 is a side view of the track shoe blank of FIG. 4 provided with leading and trailing edges.

FIG. 6 is a side view of a grouser being linearly friction welded to the track shoe blank of FIG. 5.

FIG. 7 is a side view of a track shoe fabricated in accordance with the method of FIGS. 4-6.

FIG. 8 is a side view of a first track shoe portion being linearly friction welded to a second track shoe portion in accordance with the present disclosure.

FIG. 9 is a side view of a track shoe fabricated in accordance with the method of FIG. 8.

FIG. 10 is a side view of a first track shoe portion being linearly friction welded to a second track shoe portion in accordance with the present disclosure.

FIG. 11 is a side view of a track shoe fabricated in accordance with the method of FIG. 10.

FIG. 12 is a perspective view of a grouser being orbitally friction welded to a track shoe blank in accordance with the present disclosure.

FIG. 13 is a perspective view of a first track shoe portion being orbitaily friction welded to a second track shoe portion in accordance with the present disclosure.

FIG. 14 is a perspective view of a first track shoe portion being orbitally friction welded to a second track shoe portion in accordance with the present disclosure,

### DETAILED DESCRIPTION

The present disclosure relates to a track shoe and methods of fabricating a track shoe using friction welding.

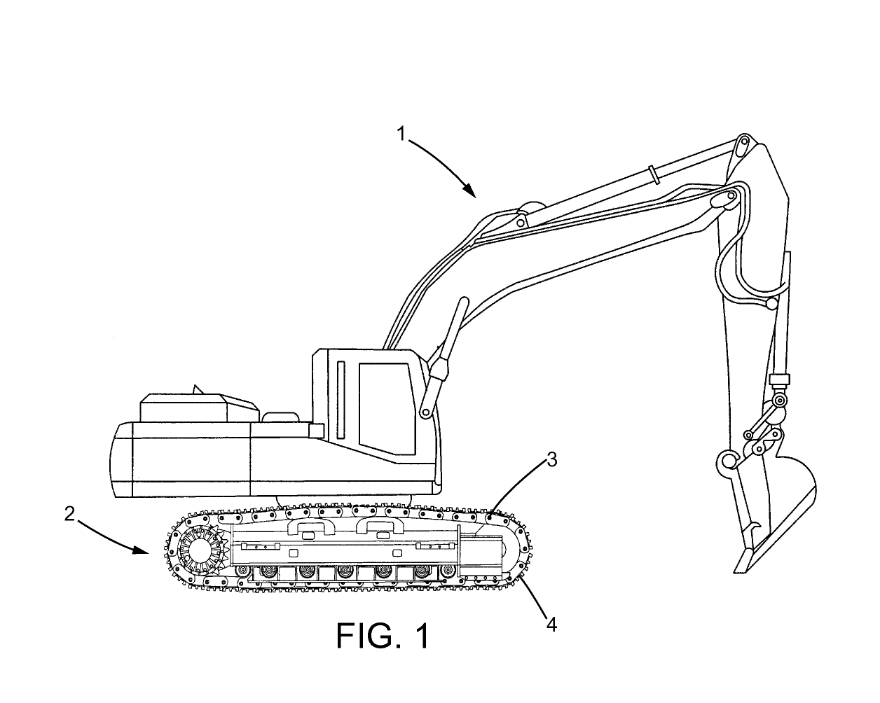

FIG. 1 illustrates a machine 1 including an undercarriage system 2 with a track assembly 3 having an endless track 4, consistent with the present disclosure. Although machine 1 is illustrated as an excavator, machine 1 may be of any other type that includes an endless track 4. As used herein, the term “machine” refers to a mobile track-type machine that performs a driven operation involving physical movement associated with a particular industry, such as earthmoving, construction, landscaping, forestry, and agriculture, Examples of machine 1 include machines such as earth-moving vehicles, excavators, tractors, dozers, loaders, backhoes, agricultural equipment, material handling equipment, and other types of machines that operate in a work environment. It is to be understood that machine 1 is shown primarily for illustrative purposes to assist in disclosing features of the present disclosure and that FIG. 1 does not depict all of the components of machine 1.

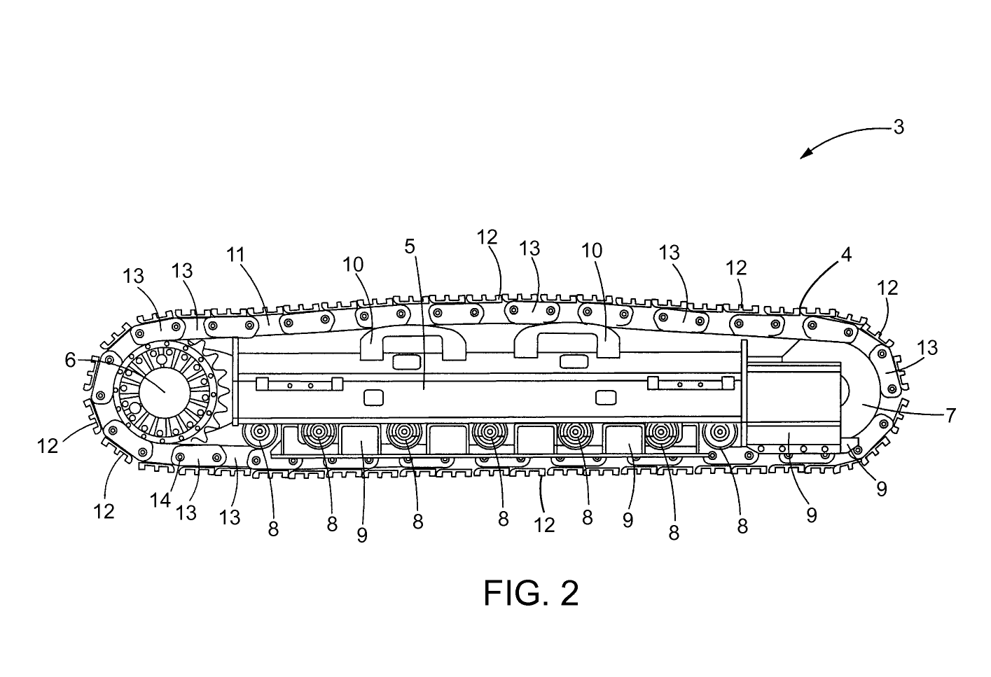

The undercarriage system 2 supports machine 1 and moves machine 1 along the ground, roads, and other types of terrain. As shown in FIG. 2, the track assembly 3 of the undercarriage system 2 may include a track roller frame 5, various guiding components connected to the track roller frame 5, and an endless track 4 engaging the guiding components. The guiding components guide the endless track 4 and include a drive sprocket 6, an idler 7, rollers 8, track guides 9, and carriers 10, although other components may be used. For clarity, only certain representative instances of the various components of track assembly 3 are identified with reference numerals in FIG. 2. It will be understood that the other non-numbered instances of the same components perform the same function and have the same structure as the components that do include reference numerals.

Endless track 4 may include a link assembly 11 with a plurality of track shoes 12 secured thereto. Each track shoe 12 on link assembly 11 is adjacent to and in engagement with another track shoe 12 on either side thereof, forming endless track 4. The link assembly 11 forms a flexible backbone of endless track 4, and the track shoes 12 provide traction on the surface on which machine 1 is located, Link assembly 11 extends in an endless track 4 around drive sprocket 6, rollers 8, idler 7, and carriers 10. More specifically, link assembly 11 includes a plurality of links 13 connected to one another at pivot joints 14, with each link 13 including a track shoe 12 attached thereto. Undercarriage system 2 could have other configurations.

A track shoe 12 according to the present disclosure is shown in FIG, 3. Track shoe 12 includes a grouser 15 protruding from flat portion 16. As machine 1 travels on a surface, grouser 15 conies into contact with the surface, increasing the traction of endless track 4. In the embodiment shown, grouser 15 protrudes generally orthogonally from flat portion 16, yet grouser 15 may protrude at other angles with respect to flat portion 16, including acute and obtuse angles. Although grouser 15 is shown as having a generally quadrilateral-type profile, grouser 15 may have a different profile, including a generally triangular profile or a claw-type profile. Track shoe 12 may also have more than one grouser 15 attached thereto.

Track shoe 12 includes a leading edge 17 and a trailing edge 18. Leading edge 17 is tapered and angled with respect to fiat portion 16 of track shoe blank 19 in a direction generally opposite from the direction in which grouser 15 protrudes from track shoe blank 19. Trailing edge 18 is tapered and angled with respect to flat portion 16 of track shoe blank 19 in generally the same direction in which grouser 15 protrudes from track shoe blank 19. In this manner, when a plurality of track shoes 12 are joined together to form endless track 4 on track assembly 3, the leading edge 17 of a first track shoe 12 is proximal to a trailing edge 18 of an adjacent track shoe 12.

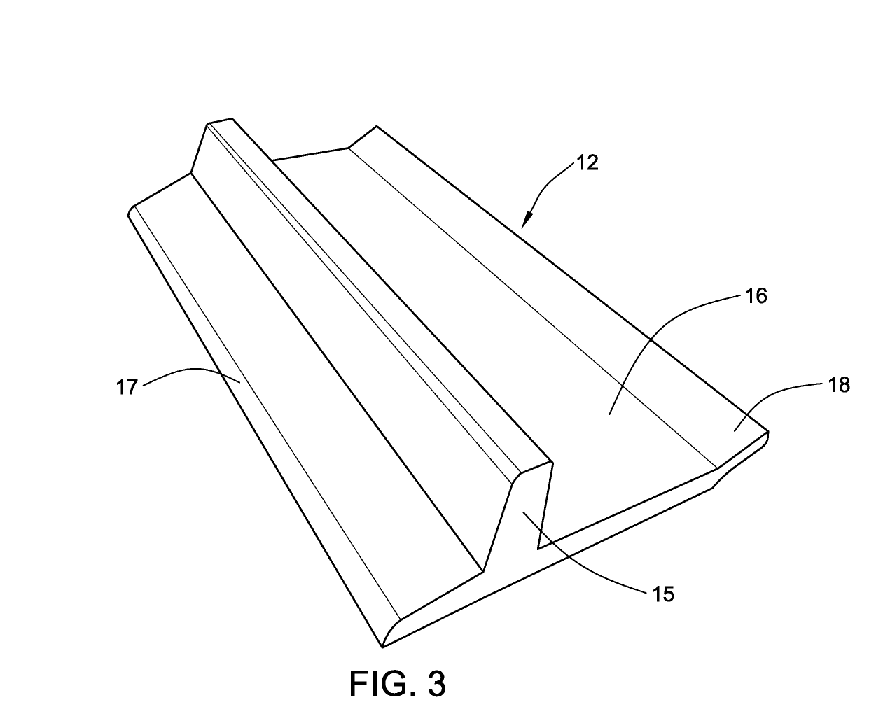

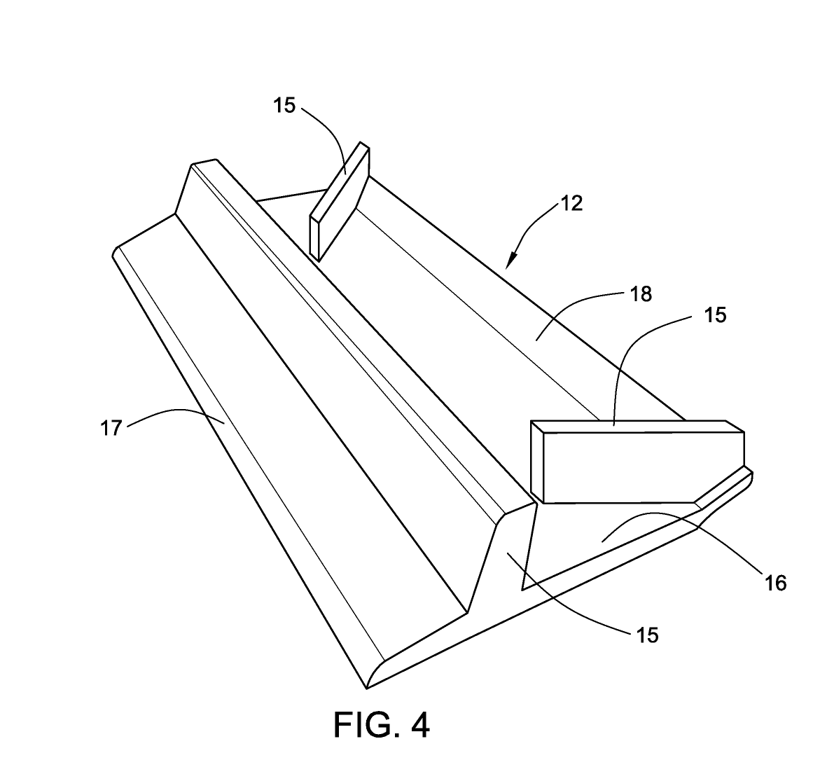

Another variation of track shoe 12 according to the present disclosure is shown in FIG. 4. Track shoe 12 in FIG. 4 is the same as track shoe 12 in FIG. 3, except that track shoe 12 in FIG. 4 has additional grousers 15 protruding from fiat portion 16 that are arranged at an angle with respect to the grouser 15 that spans the width of the track shoe 12 or with respect to trailing edge 18. A track shoe of this type is called a “chopper” shoe, and may help deter debris present on the terrain on which machine 1 travels from adhering to the track shoe 12. While FIG. 4 shows additional grousers 15 at an angle of approximately 45° with respect to the grouser 15 that spans the width of the track shoe 12 or with respect to the trailing edge 18, the angle may be different, for example 30° or 60°. Furthermore, the additional grousers 15 may be shorter in length than the grouser 15 that spans the width of the track shoe 12. A track shoe 12 according to the present disclosure may include one or more of any of the grousers 15 shown in FIG. 4. Furthermore, the disclosure herein of various friction welding techniques is equally applicable to all grousers 15 shown in FIG. 4.

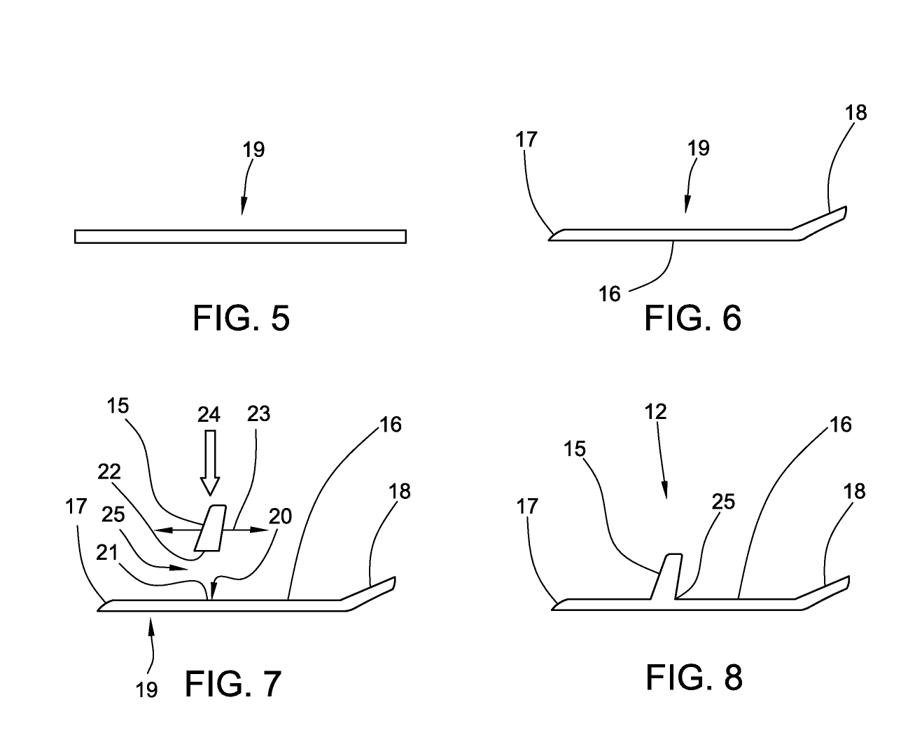

FIGS. 5-8 show a method of fabricating a track shoe 12 with a grouser 15 that includes attaching the grouser 15, which is initially a separate component, to a track shoe blank 19 using friction welding, in particular linear friction welding. Friction welding is a technique for generating mechanical friction between a first abutment surface of a first component and a second abutment surface of a second component in order to create enough welding heat between the first and second abutment surfaces to fuse them together. In one variation, the first component is held stationary. The second component is brought within close proximity of the first component such that the first abutment surface of the first component contacts the second abutment surface of the second component at an abutment surface interface, The second component is vibrated back and forth in a direction of vibration that is generally parallel to the first abutment surface of the first component and at the same time subjected to an upset force that is perpendicular to the direction of vibration that pushes the second abutment surface of the second, vibrating component into the first abutment surface of the first component. The first abutment surface of the first component is then fused to the second abutment surface of the second component at the abutment surface interface, creating a single piece comprising the first component friction welded to the second component. This variation of friction welding is referred to as linear friction welding. Excess flash or waste material produced near the abutment surface interface can be removed, for example with a laser, The range of motion of the vibrated second component in the direction of vibration is typically a few millimeters, white the frequency of vibration is high, for example approximately 100-200 Hz, Unlike traditional welding techniques, friction welding permits the fusing of components made of dissimilar materials, such as aluminum and steel.

In one embodiment, track shoe 12 is formed from track shoe blank 19. FIG. 5 shows the profile of track shoe blank 19. Track shoe blank 19 may be made of metal, for example steel. Track shoe blank 19 may be of a standardized form, meaning that a large number of track shoe blanks 19 can be readily obtained in large quantities from any number of suppliers and/or that track shoe blank 19 does not require significant manufacturing expense to produce. Track shoe blank 19 can have any suitable configuration.

As shown in FIG. 6, flat portion 16 of track shoe blank 19 connects leading edge 17 and trailing edge 18. Track shoe blank 19 may be provided with leading edge 17 and trailing edge 18 prior to linearly friction welding grouser 15 to track shoe blank 19. Alternatively, track shoe blank 19 may be provided with leading edge 17 and trailing edge 18 after linearly friction welding grouser 15 to track shoe blank 19.

FIG. 7 shows grouser 15 being linearly friction welded to track shoe blank 19. The distances between various components shown in FIG. 7 and in the other Figures are intended to be representative and not indicative of the actual distances between the components. More particularly, the distances have been increased so as to more clearly show the features of the present disclosure. A person of ordinary skill in the art would understand that two surfaces must be in contact if they are to be friction welded together.

In order to linearly friction weld grouser 15 to track shoe blank 19, track shoe blank 19 is held stationary, for example in a press or a chuck. Grouser 15 is brought within close proximity of a target fusing location 20 on track shoe blank 19 where grouser 15 is to be attached. In the embodiment shown, target fusing location 20 is disposed on flat portion 16 of track shoe blank 19. Target fusing location 20 may be in other locations on track shoe blank 19. When grouser 15 is in close proximity of target fusing location 20, a second abutment surface 22 on grouser 15 contacts a first abutment surface 21 of track shoe blank 19 at an abutment surface interface 25. Grouser 15 is then vibrated back and forth in a direction of vibration 23 that is generally parallel to flat portion 16 of track shoe blank 19 and orthogonal to an upset force 24 that acts on grouser 15 to push second abutment surface 22 into first abutment surface 21 at target fusing location 20. The vibration of grouser 15 in the direction of vibration 23 results in an overall range of movement of grouser 15 in the direction of vibration 23 of a few millimeters. As a result of the upset force 24 pushing second abutment surface 22 of grouser 15 into first abutment surface 21 of track shoe blank 19 and the vibration of grouser 15 with respect to track shoe blank 19, second abutment surface 22 of grouser 15 fuses with first abutment surface 21 of track shoe blank 19 at abutment surface interface 25, creating a track shoe 12 comprising track shoe blank 19 with grouser 15 attached thereto. The linearly friction welded track shoe 12 is shown in FIG. 8.

Although FIG. 7 shows grouser 15 being vibrated back and forth in a direction of vibration 23 that lies in the plane of the page, it is also contemplated that grouser 15 may instead be vibrated back and forth in a direction of vibration 23 that lies in a plane that is orthogonal to the plane of the page, i.e., a vertical or horizontal plane that comes out of the plane of the page in the direction of the viewer. In both cases, grouser 15 is vibrated back and forth in a direction of vibration 23 that is generally parallel to flat portion 16 of track shoe blank 19, whether parallel within the plane of the page or parallel within vertical or horizontal plane that is orthogonal to the plane of the page.

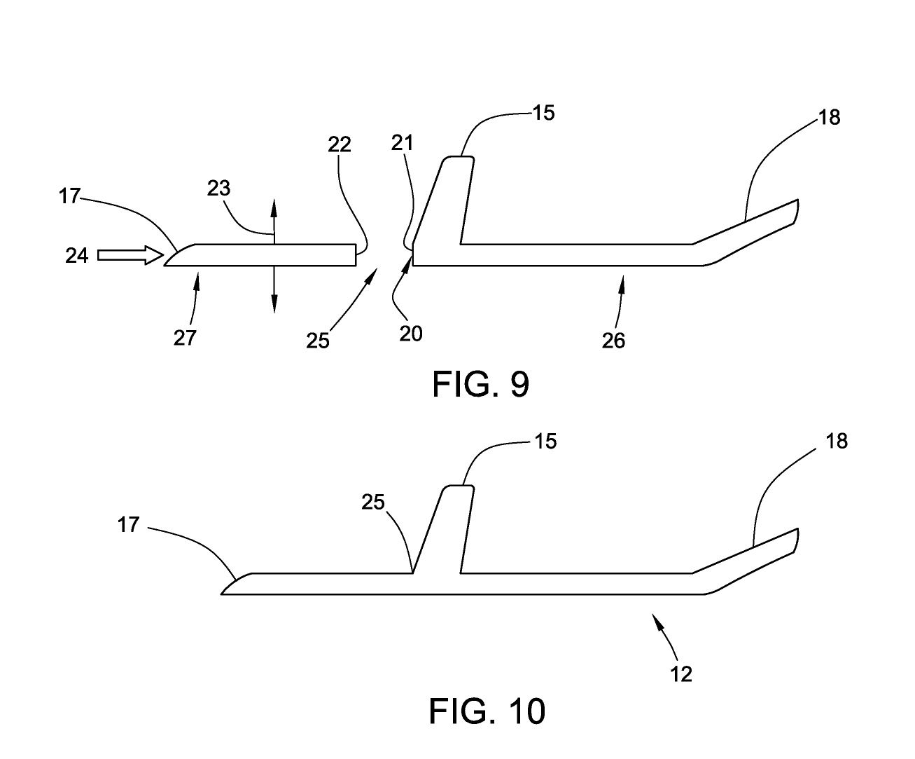

Another embodiment of a method of fabricating a track shoe using linear friction welding is shown in FIGS. 9-10. The method includes linearly friction welding a first track shoe portion 26 to a second track shoe portion 27. In this embodiment, first track shoe portion 26 includes a grouser 15 protruding from first track shoe portion 26 and a trailing edge 18, and second track shoe portion 27 includes a leading edge 17.

In order to linear friction weld first track shoe portion 26 to second track shoe portion 27, first track shoe portion 26 is held stationary. Second track shoe portion 27 is brought within close proximity of a target fusing location 20 on first track shoe portion 26 where second track shoe portion 27 is to be attached. In the embodiment shown, target fusing location 20 is disposed adjacent to grouser 15 of first track shoe portion 26. Target fusing location 20 may be in other locations on first track shoe portion 26, When second track shoe portion 27 is in close proximity of target fusing location 20, a second abutment surface 22 on second track shoe portion 27 contacts a first abutment surface 21 of first track shoe portion 26 at an abutment surface 25. Second track shoe portion 27 is then vibrated back and forth in a direction of vibration 23 that is generally parallel to first abutment surface 21 and generally orthogonal to an upset force 24 that acts on second track shoe portion 27 to push second abutment surface 22 into first abutment surface 21. The vibration of second track shoe portion 27 in the direction of vibration 23 results in an overall range of movement of second track shoe portion 27 in the direction of vibration 23 of a few millimeters. As a result of the upset force 24 pushing second abutment surface 22 of second track shoe portion 27 into first abutment surface 21 of first track shoe portion 26 and the vibration of second track shoe portion 27 with respect to first track shoe portion 26, second abutment surface 22 of second track shoe portion 27 fuses with first abutment surface 21 of first track shoe portion 26 at abutment surface interface 25, creating a track shoe 12 comprising first track shoe portion 26 and second track shoe portion 27. The linearly friction welded track shoe 12 is shown in FIG. 10.

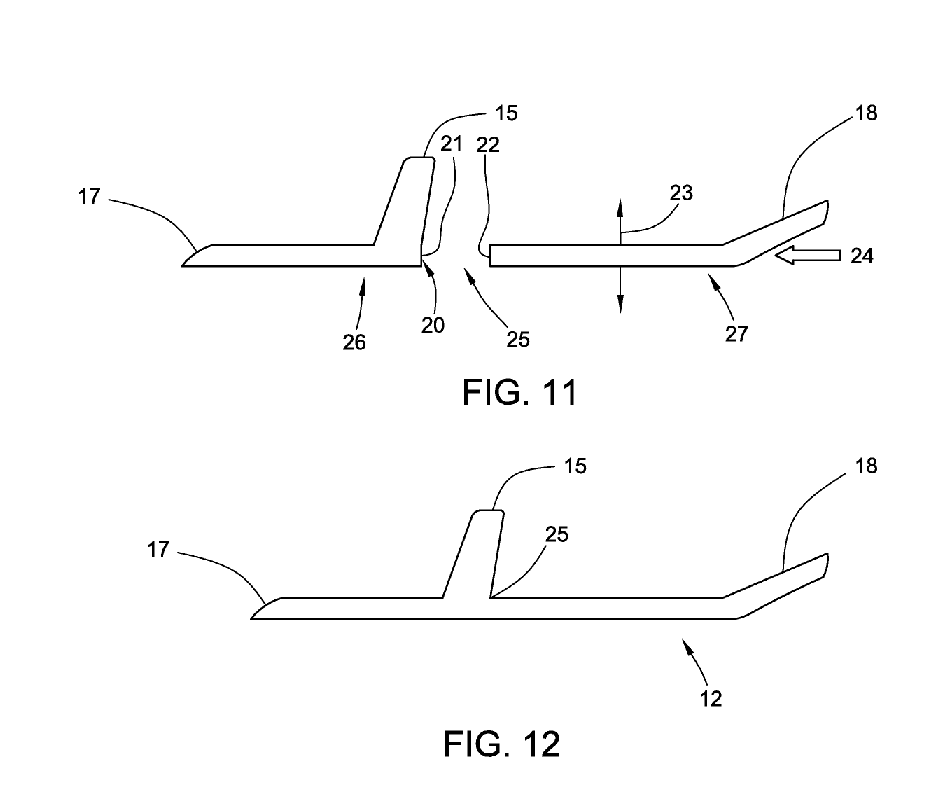

Yet another embodiment of a method of fabricating a track shoe using linear friction welding is shown in FIGS. 11-12. The method is the same as that of the previous embodiment except that first track shoe portion 26, rather than second track shoe portion 27, includes leading edge 17, and second track shoe portion 27, rather than first track shoe portion 26, includes trailing edge 18. FIG. 11 shows first track shoe portion 26 and second track shoe portion 27 during the linear friction welding process, while FIG. 12 shows the track shoe 12 fabricated according to the linear friction welding process of FIG. 11.

In another embodiment, track shoe blank 19 may be a second track shoe portion 27 and grouser 15 may be disposed on a first track shoe portion 26. First track shoe portion 26 may be friction welded to second track shoe portion 27 to fabricate a track shoe 12 comprising the first track shoe portion 26 with grouser 15 and the second track shoe portion 27.

Although FIGS. 9 and 11 show second track shoe portion 27 being vibrated back and forth in a direction of vibration 23 that lies in the plane of the page, it is also contemplated that second track shoe portion 27 may instead be vibrated back and forth in a direction of vibration 23 that lies in a plane that is orthogonal to the plane of the page, i.e., a vertical or horizontal plane that comes out of the plane of the page in the direction of the viewer. In both cases, second track shoe portion 27 is vibrated back and forth in a direction of vibration 23 that is generally parallel to first abutment surface 21 of first track shoe portion 26, whether parallel within the plane of the page or parallel within a vertical or horizontal plane that is orthogonal to the plane of the page.

In linear friction welding, typically the more massive component of the two components to be fused to together (that is track shoe blank 19 rather than grouser 15 and first track shoe portion 26 rather than second track shoe portion 27) is held stationary while the less massive component is vibrated and subjected to an upset force. It is also contemplated, however, that the less massive component (i.e., grouser 15 rather than track shoe blank 19 and second track shoe portion 27 rather than first track shoe portion 26) can be held stationary while the more massive component is vibrated and subjected to an upset force.

Orbital friction welding is another friction welding technique contemplated in the present disclosure. In orbital friction welding, a first abutment surface of a first component is brought within close proximity of a second abutment surface of a second component such that the first abutment surface contacts the second abutment surface at an abutment surface interface. Initially, the first component is displaced from the second component along the plane of the abutment surface interface by a small distance, or offset, such that the first abutment surface is not aligned, or is not congruent, with the second abutment surface. The offset is typically one or a few millimeters. The first component is then rotated with respect to the second component, or, alternatively, the second component is rotated with respect to the first component, along a small circular or elliptical path, or orbit, while both the first component and the second component are subjected to equal and opposite upset forces that push the first abutment surface into the second abutment surface, creating welding heat at the abutment surface interface. As the rotation along the orbit continues, the magnitude of each upset force is held constant or increased and the offset is continually decreased until it becomes zero, at which point the first abutment surface becomes aligned, or congruent, with the second abutment surface. The first abutment surface of the first component is then fused to the second abutment surface of the second component at the abutment surface interface, creating a single piece comprising the first component orbitally friction welded to the second component. Excess flash or waste material produced near the abutment surface interface can be removed, for example with a laser.

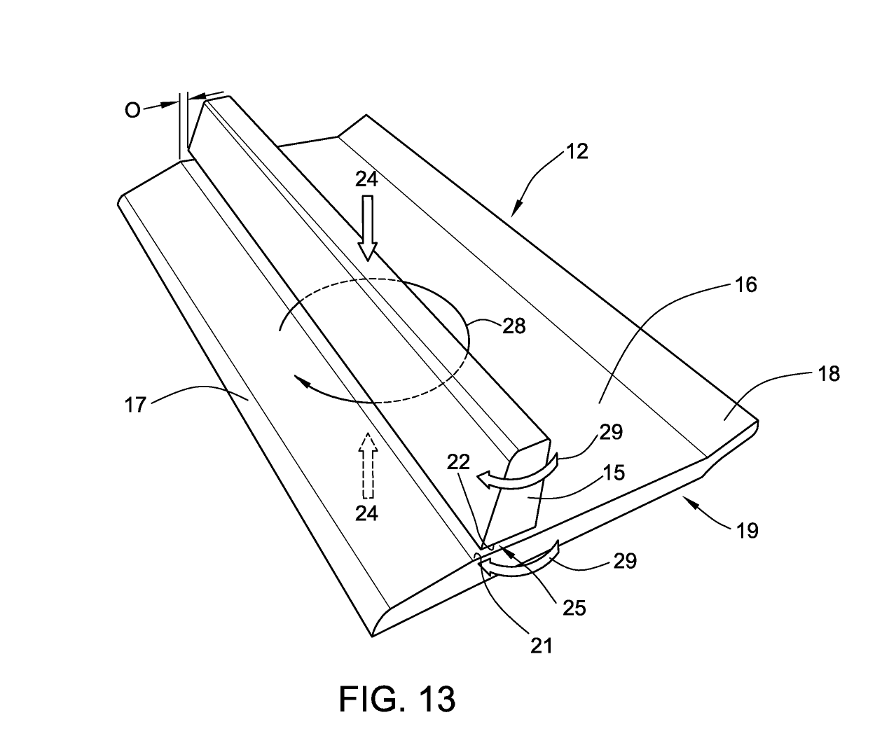

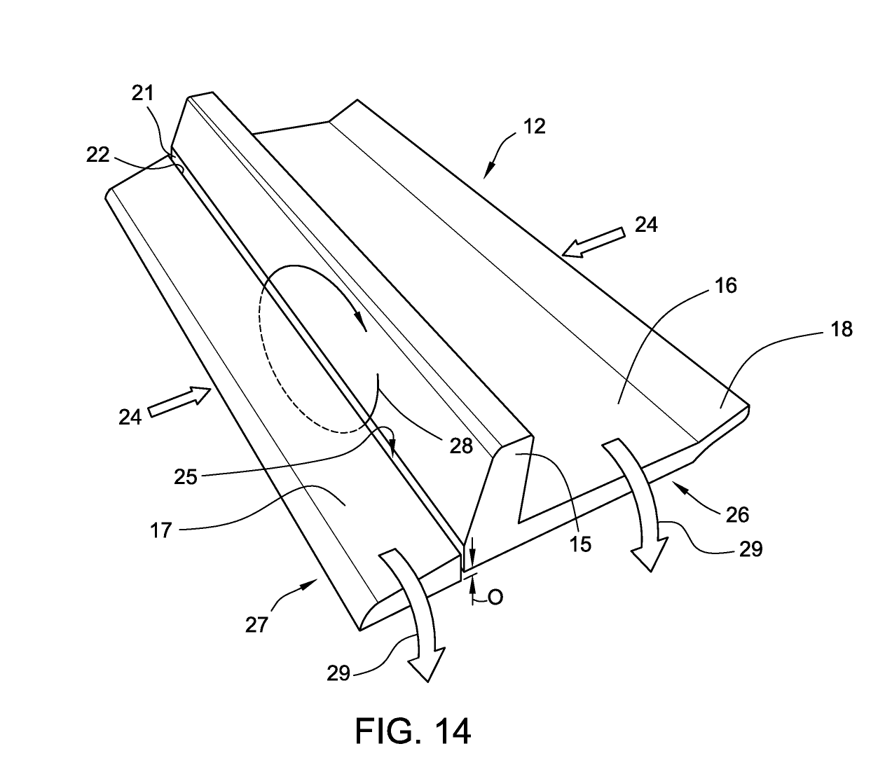

FIGS. 13-14 show additional embodiments of methods of fabricating a track shoe using friction welding, in particular orbital friction welding. The method in FIG. 13 includes orbitally friction welding a grouser 15 to a track shoe blank 19. As shown in FIG. 13, track shoe blank 19 includes a leading edge 17 separated from a trailing edge 18 by a fiat portion 16 of track shoe blank 19. Track shoe blank 19 may be provided with leading edge 17 and trailing edge 18 prior to orbitally friction welding grouser 15 to track shoe blank 19. Alternatively, track shoe blank 19 may be provided with leading edge 17 and trailing edge 18 after orbitally friction welding grouser 15 to track shoe blank 19.

In order to orbitally friction weld grouser 15 to track shoe blank 19, grouser 15 is brought within close proximity of track shoe blank 19 such that a first abutment surface 21 of track shoe blank 19 contacts a second abutment surface 22 of grouser 15 at an abutment surface interface 25. Initially, track shoe blank 19 is displaced from grouser 15 along a plane of abutment surface interface 25 by offset O, such that first abutment surface 21 is not aligned, or is not congruent, with second abutment surface 22. Grouser 15 is then rotated with respect to track shoe blank 19 or, alternatively, track shoe blank 19 is rotated with respect to grouser 15, along orbit 28 in direction of rotation 29, while both track shoe blank 19 and grouser 15 are subjected to equal and opposite upset forces 24 that push first abutment surface 21 into second abutment surface 22, creating welding heat at the abutment surface interface 25. As the rotation along orbit 28 continues, the magnitude of each upset force 24 is held constant or increased and offset O is continually decreased until it becomes zero, at which point first abutment surface 21 becomes aligned, or congruent, with second abutment surface 22. First abutment surface 21 of track shoe blank 19 is then fused to second abutment surface 22 of grouser 15 at abutment surface interface 25, creating a track shoe 12 comprising the grouser 15 orbitally friction welded to the track shoe blank 19.

Although FIG. 13 shows orbit 28 as being circular, orbit 28 may instead be elliptical. Additionally, while FIG. 13 shows both grouser 15 and track shoe blank 19 being rotated along orbit 28 in direction of rotation 29, it will be understood that only one of grouser 15 and track shoe blank 19 must be rotated along orbit 28 to generate the welding heat necessary to fuse first abutment surface 21 of track shoe blank 19 to second abutment surface 22 of grouser 15.

The method shown in FIG. 14 includes orbitally friction welding a first track shoe portion 26 to a second track shoe portion 27. In this embodiment, first track shoe portion 26 includes a grouser 15 and a trailing edge 18, and second track shoe portion 27 includes a leading edge 17. In an alternative embodiment, shown in FIG. 11 for example, first track shoe portion 26, rather than second track shoe portion 27, could include leading edge 17, and second track shoe portion 27, rather than first track shoe portion 26, could include trailing edge 18.

Referring again to FIG. 14, in order to orbitally friction weld first track shoe portion 26 to second track shoe portion 27, first track shoe portion 26 is brought within close proximity of second track shoe portion 27 such that a first abutment surface 21 of first track shoe portion 26 contacts a second abutment surface 22 of second track shoe portion 27 at an abutment surface interface 25. Initially, first track shoe portion 26 is displaced from second track shoe portion 27 along the plane of abutment surface interface 25 by offset O, such that first abutment surface 21 is not aligned, or is not congruent, with second abutment surface 22. First track shoe portion 26 is then rotated with respect to second track shoe portion 27, or, alternatively, second track shoe portion 27 is rotated with respect to first track shoe portion 26, along orbit 28, while at the same time each being subjected to equal and opposite upset forces 24 that push first abutment surface 21 into second abutment surface 22, creating welding heat at the abutment surface interface 25. As the rotation along orbit 28 continues, the magnitude of each upset force 24 is held constant or increased and offset O is continually decreased until it becomes zero, at which point first abutment surface 21 becomes aligned, or congruent, with second abutment surface 22, First abutment surface 21 of first track shoe portion 26 is then fused to second abutment surface 22 of second track shoe portion 27 at abutment surface interface 25, creating a track shoe 12 comprising the first track shoe portion 26 orbitally friction welded to the second track shoe portion 27.

Although FIG. 14 shows orbit 28 as being circular, orbit 28 may instead be elliptical. Additionally, while FIG. 14 shows both first track shoe portion 26 and second track shoe portion 27 being rotated along orbit 28 in direction of rotation 29, it will be understood that only one of first track shoe portion 26 and second track shoe portion 27 must be rotated along orbit 28 to generate the welding heat necessary to fuse first abutment surface 21 of first track shoe portion 26 to second abutment surface 22 of second track shoe portion 27.

First track shoe portion 26 and second track shoe portion 27 may be of a standardized form, meaning that a large number of first track shoe portions 26 and second track shoe portions 27 can be readily obtained in large quantities from any number of suppliers and/or that first track shoe portion 26 and second track shoe portion 27 do not require significant manufacturing expense to produce. For example, first track shoe portion 26 shown in FIGS. 9, 11, and 14 could be cut from a standard L-beam or I-beam section of material, whereas second track shoe portion 27 could be cut from a standard bar of material. The material could be steel for example.

While first track shoe portion 26 and second track shoe portion 27 of FIGS. 9-12 and 13 are provided with either a leading edge 17 or a trailing edge 18 prior to being friction welded together, it is contemplated that first track shoe portion 26 and second track shoe portion 27 could instead be provided with either a leading edge 17 or a trailing edge 18 after they are friction welded together.

In orbital friction welding, typically the more massive component of the two components to be fused together (i.e., track shoe blank 19 rather than grouser 15 and first track shoe portion 26 rather than second track shoe portion 27) is held stationary while the less massive component is rotated with respect to the more massive component. It is also contemplated, however, that the less massive component (i.e., grouser 15 rather than track shoe blank 19 and second track shoe portion 27 rather than first track shoe portion 26) can be held stationary while the more massive component is rotated with respect to the less massive component.

It is also contemplated that one or more of track shoe blank 19, grouser 15, first track shoe portion 26, and second track shoe portion 27 may be comprised of two or more components that have already been friction welded together, whether by linear friction welding or orbital friction welding. For example, referring to FIG. 14, first track shoe portion 26 may comprise a grouser 15 friction welded to a first side of a flat portion 16, and a trailing edge 18 friction welded to the other side of flat portion 16. First track shoe portion 26, comprised of these three separate components (i.e., grouser 15, flat portion 16, and trailing edge 18), may then be friction welded to second track shoe portion 27 to fabricate a track shoe 12.

It is further contemplated that first abutment surface 21 and second abutment surface 22 may each be comprised of a number of discrete surfaces. For example, while FIG. 14 shows first abutment surface 21 as a single, continuous surface that stretches along a width of first track shoe portion 26, alternatively, first abutment surface 21 may be comprised of a number of discrete surfaces, which collectively have a smaller total surface area than when first abutment surface 21 is comprised of a single, continuous surface as shown in FIG. 14. Second abutment surface 22 may be similarly formed. The discrete surfaces may be characterized as protrusions. Decreasing or minimizing the total overall surface area to be friction welded may increase efficiency of the friction welding techniques of the present disclosure, while still maintaining a sufficiently strong friction weld between the first abutment surface 21 and second abutment surface 22.

### INDUSTRIAL APPLICABILITY

In general, the methods and track shoes of the present disclosure are applicable for use in various industrial applications, such as earthmoving, construction, landscaping, forestry, and agricultural machines. In particular, the disclosed methods and resulting track shoes may be used on any machine with an endless track on the tracked undercarriage, such as earth-moving vehicles, excavators, tractors, dozers, loaders, backhoes, agricultural equipment, material handling equipment, and the like.

Fabricating a track shoe according to the methods of the present disclosure may provide a less costly and more efficient alternative to current fabrication techniques, which require expensive tooling and extrusion procedures. More specifically, current fabrication techniques typically require extruding a lengthy rectangular beam of steel into a desired track shoe shape, cutting the extruded piece material into appropriately sized sections, punching a hole in each section where a grouser is to be attached, and attaching the grouser to the cut section. Fabricating a track shoe according to the methods of the present disclosure, in contrast, may allow for the fabrication of a track shoe using friction welding, which may reduce fabrication complexity and result in lower fabrication costs. The disclosed methods may also limit the need for the expensive tooling and extrusion procedures of current fabrication techniques. In particular, the methods of the present disclosure may be used to fabricate a smaller number of track shoes, to fabricate track shoes for legacy machines for which replacement parts may be difficult to find, and to fabricate track shoes that include grousers for larger machines.

This disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A method of fabricating a track shoe, comprising:
friction welding a grouser to a track shoe blank.

2. The method of fabricating a track shoe of claim 1, wherein the friction welding comprises linear friction welding.

3. The method of fabricating a track shoe of claim 2, wherein the linear friction welding comprises:
holding the track shoe blank stationary;
bringing the grouser within close proximity of the track shoe blank such that a first abutment surface on the track shoe blank contacts a second abutment surface on the grouser at an abutment surface interface;
vibrating the grouser in a direction of vibration that is generally parallel to the first abutment surface;
subjecting the grouser to an upset force that is generally orthogonal to the direction of vibration to push the second abutment surface into the first abutment surface; and
fusing the grouser to the track shoe blank at the abutment surface interface.

4. The method of fabricating a track shoe of claim 1, wherein the friction welding comprises orbital friction welding.

5. The method of fabricating a track shoe of claim 4, wherein the orbital friction welding comprises:
bringing the grouser within close proximity of the track shoe blank such that a first abutment surface on the track shoe blank contacts a second abutment surface on the grouser at an abutment surface interface;
displacing the grouser from the track shoe blank along a plane coinciding with the abutment surface interface by an offset;
rotating the track shoe blank with respect to the grouser, or, alternatively, the grouser with respect to the track shoe blank, along an orbit;
subjecting the track shoe blank and the grouser to equal and opposite upset forces to push the first abutment surface into the second abutment surface;
decreasing the offset until the first abutment surface is aligned with the second abutment surface; and
fusing the grouser to the track shoe blank at the abutment surface interface.

6. The method of fabricating a track shoe of claim 1, wherein the grouser protrudes from a flat portion of the track shoe blank and the track shoe blank further comprises:
a leading edge angled in a direction generally opposite from the direction in which the grouser protrudes from the flat portion; and
a trailing edge angled in generally the same direction in which the grouser protrudes from the flat portion.

7. The method of fabricating a track shoe of claim 1, wherein the grouser and the track shoe blank are dissimilar materials.

8. A method of fabricating a track shoe, comprising:
friction welding a first track shoe portion that includes a grouser to a second track shoe portion.

9. The method of fabricating a track shoe of claim 8, wherein the friction welding comprises linear friction welding.

10. The method of fabricating a track shoe of claim 9, wherein the linear friction welding comprises:
holding the first track shoe portion stationary;
bringing the first track shoe portion within close proximity of the second track shoe portion such that a first abutment surface on the first track shoe portion contacts a second abutment surface on the second track shoe portion at an abutment surface interface;
vibrating the second track shoe portion in a direction of vibration that is generally parallel to the first abutment surface;
subjecting the second track shoe portion to an upset force that is generally orthogonal to the direction of vibration to push the second abutment surface into the first abutment surface; and
fusing the second track shoe portion to the first track shoe portion at the abutment surface interface.

11. The method of fabricating a track shoe of claim 8, wherein the friction welding comprises orbital friction welding.

12. The method of fabricating a track shoe of claim 11, wherein the orbital friction welding comprises:
bringing the first track shoe portion within close proximity of the second track shoe portion such that a first abutment surface on the first track shoe portion contacts a second abutment surface on the second track shoe portion at an abutment surface interface;
displacing the second track shoe portion from the first track shoe portion along a plane coinciding with the abutment surface interface by an offset;
rotating the first track shoe portion with respect to the second track shoe portion, or, alternatively, the second track shoe portion with respect to the first track shoe portion, along an orbit;
subjecting the first track shoe portion and the second track shoe portion to equal and opposite upset forces to push the first abutment surface into the second abutment surface;
decreasing the offset until the first abutment surface is aligned with the second abutment surface; and
fusing the second track shoe portion to the first track shoe portion at the abutment surface interface.

13. The method of fabricating a track shoe of claim 8, wherein the grouser protrudes from the first track shoe portion, the first track shoe portion includes a trailing edge angled in generally the same direction in which the grouser protrudes from the first track shoe portion, and the second track shoe portion includes a leading edge angled in a direction generally opposite from the direction in which the grouser protrudes from the first track shoe portion.

14. The method of fabricating a track shoe of claim 8, wherein the grouser protrudes from the first track shoe portion, the first track shoe portion includes a leading edge angled in a direction generally opposite from the direction in which the grouser protrudes from the first track shoe portion, and the second track shoe portion includes a trailing edge angled in generally the same direction in which the grouser protrudes from the first track shoe portion.

15. A method of fabricating a track shoe, comprising:
providing a track shoe blank;
providing a grouser;
placing the grouser such that it protrudes from a flat portion of the track shoe blank; and
fusing the grouser to the track shoe blank by friction welding.

16. The method of fabricating a track shoe of claim 15, wherein the track shoe blank includes a leading edge angled in a direction generally opposite from the direction in which the grouser protrudes from the flat portion and a trailing edge angled in generally the same direction in which the grouser protrudes from the flat portion, and wherein the leading edge and the trailing edge are connected by the flat portion.

17. The method of fabricating a track shoe of claim 15, wherein the grouser and the track shoe blank are dissimilar materials.

18. The method of fabricating a track shoe of claim 15, wherein the grouser is disposed on a first track shoe portion, and
the track shoe blank is a second track shoe portion.

19. The method of fabricating a track shoe of claim 18, wherein the grouser protrudes from the first track shoe portion, the first track shoe portion includes a trailing edge angled in generally the same direction in which the grouser protrudes from the first track shoe portion, and the second track shoe portion includes a leading edge angled in a direction generally opposite from the direction in which the grouser protrudes from the first track shoe portion.

20. The method of fabricating a track shoe of claim 18, wherein the grouser protrudes from the first track shoe portion, the first track shoe portion includes a leading edge angled in a direction generally opposite from the direction in which the grouser protrudes from the first track shoe portion, and the second track shoe portion includes a trailing edge angled in generally the same direction in which the grouser protrudes from the first track shoe portion.
